(19) United States
(12) Patent Application Publication
(10) Pub. No.: US 2020/0231180 A1
(43) Pub. Date: Jul. 23, 2020

(54) TRAVEL CONTROL DEVICE AND TRAVEL CONTROL METHOD

(71) Applicant: ISUZU MOTORS LIMITED, Tokyo (JP)

(72) Inventor: Naoki TAKAHASHI, Yokohama-shi, Kanagawa (JP)

(21) Appl. No.: 16/482,811

(22) PCT Filed: Feb. 1, 2018
(86) PCT No.: PCT/JP2018/003426

§ 371 Date: Aug. 1, 2019

(30) Foreign Application Priority Data
Feb. 3, 2017 (JP) 2017-018712

(51) Int. Cl. B60W 60/00; B60W 30/18

(52) U.S. Cl. CPC B60W 60/0025; B60W 60/0021; B60W 2552/00; B60W 2556/50; B60W 30/18072

(57) ABSTRACT

An automatic travel control unit (120) of this travel control device (100) makes a vehicle travel according to a travel schedule including driven travel and inertial travel. When information indicating that appropriate navigation information cannot be output from a navigation device (20), the inertial travel control unit (110) prohibits the automatic travel control unit (120) from controlling inertial travel. Thus, the inertial travel control unit (110) can make a vehicle (1) perform inertial travel.

### TECHNICAL FIELD

The present disclosure relates to a travel control device and a travel control method for controlling travel of a vehicle.

### BACKGROUND ART

Patent Literature (hereinafter, referred to as “PTL”) 1 discloses that a road section in which coasting travel can be performed is selected and extracted in advance based on a road condition and a traffic condition, and is accumulated in a map database of a car navigation system. PTL 1 also discloses performing the coasting travel in a case where a road on which a vehicle is currently traveling is a road on which the coasting travel can be performed.

### CITATION LIST

### Patent Literature

PTL 1

Japanese Patent Application Laid-Open No. 2012-031959

### SUMMARY OF INVENTION

### Technical Problem

However, there is a possibility in PTL 1 that the coasting travel of the vehicle cannot be appropriately performed depending on a state of a navigation device. Impossibility of appropriately controlling the coasting travel may, for example, cause an increase in speed to run the vehicle into a dangerous situation.

For example, the position of the traveling vehicle on the navigation device may be off a road on a map due to inclusion of noise in a received GPS signal. When the position of the traveling vehicle is off the road on the map, a control device that controls the coasting travel of the vehicle cannot obtain, from the navigation device, information on whether or not the road on which the vehicle travels is a road on which the coasting travel can be performed. The control device which cannot obtain the information on the coasting travel cannot control the coasting travel of the vehicle appropriately, so that the vehicle increases its speed to be run into a dangerous state, for example.

An object of the present disclosure is therefore to provide a technique which allows the vehicle to perform the coasting travel appropriately.

### Solution to Problem

A travel control device according to the present disclosure includes: an automatic travel control section that causes a vehicle to travel in accordance with a travel schedule including driven travel and coasting travel; and a coasting travel control section that prohibits the coasting travel with respect to the automatic travel control section when the coasting travel control section receives, from a navigation device, information indicating that the navigation device is not successful in outputting appropriate navigation information.

### Advantageous Effects of Invention

The travel control device of the present disclosure can cause the vehicle to perform the coasting travel appropriately.

### BRIEF DESCRIPTION OF DRAWINGS

FIG. 1 illustrates an exemplary configuration of a vehicle including a travel control device according to one embodiment of the present disclosure;

FIG. 2 illustrates an example of functional blocks of the travel control device;

FIG. 3 illustrates an example of road grade information and a travel schedule; and

FIG. 4 is a flowchart illustrating an example of operation by the travel control device.

### DESCRIPTION OF EMBODIMENTS

Hereinafter, an embodiment of the present disclosure will be described with reference to the accompanying drawings.

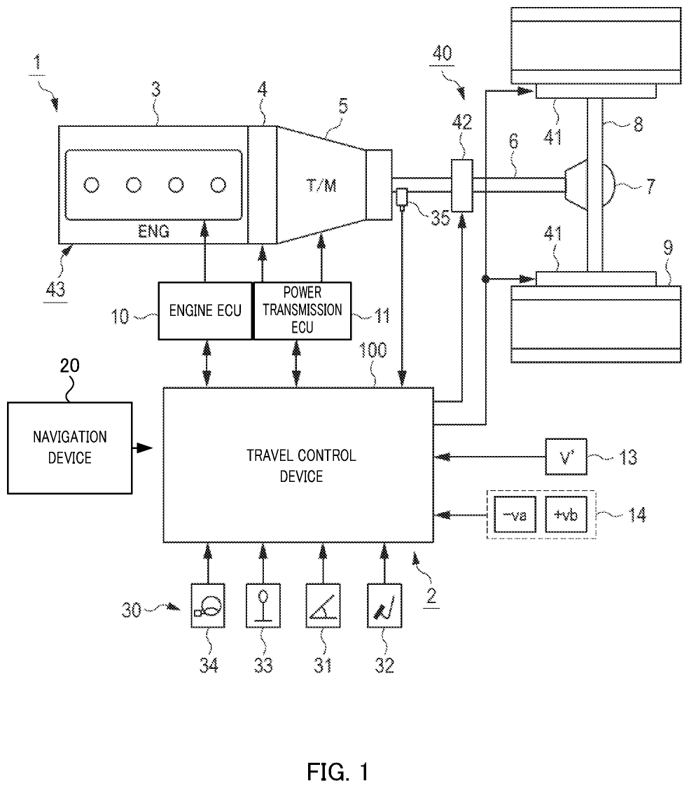

FIG. 1 illustrates an exemplary configuration of a vehicle including a travel control device according to one embodiment of the present disclosure. Vehicle 1 illustrated in FIG. 1 is, for example, a large vehicle such as a truck in which a straight-six diesel engine is mounted. Note that, the coasting travel refers to coasting travel in the case where a gear position of a gearbox is in neutral position in the following descriptions.

As illustrated in FIG. 1, vehicle 1 includes engine 3, clutch 4, gearbox (transmission) 5, thrust shaft (propeller shaft) 6, differential device (differential gear) 7, driving shaft (drive shaft) 8, and wheels 9, as components of a driving system allowing vehicle 1 to travel.

The power of engine 3 is transmitted to gearbox 5 via clutch 4. The power transmitted to gearbox 5 is further transmitted to wheels 9 via thrust shaft 6, differential device 7, and driving shaft 8. Accordingly, the power of engine 3 is transmitted to wheels 9, so that vehicle 1 travels.

Vehicle 1 also includes braking device 40 as a component of a braking system for stopping the vehicle. Braking device 40 includes footbrakes 41 for applying the resistance to wheels 9, retarder 42 for applying the resistance to thrust shaft 6, and auxiliary brake 43, such as an exhaust brake for applying a load to the engine.

Vehicle 1 further includes automatic travel device 2 as a component of a control system for controlling the automatic travel of vehicle 1. Automatic travel device 2 is a device allowing vehicle 1 to automatically travel by controlling the output of engine 3, connection or disconnection of clutch 4, and gear shift of gearbox 5, and automatic travel device 2 includes a plurality of control devices.

Specifically, automatic travel device 2 includes engine Electronic Control Unit (ECU) (engine control device) 10, power transmission ECU (power transmission control device) 11, target-vehicle-speed setting device 13, increase-value/decrease-value setting device 14, navigation device 20, vehicle information obtaining device 30, and travel control device 100. Note that, engine ECU 10, power transmission ECU 11, and travel control device 100 are connected to one another by an in-vehicle network, so that they can transmit and receive required data and control signals to and from one another.

Engine ECU 10 controls the output of engine 3. Power transmission ECU 11 controls the connection or disconnection of clutch 4 and the gear shift of gearbox 5.

Target-vehicle-speed setting device 13 sets, for travel control device 100, target vehicle speed V′ of vehicle 1 during automatic travel. Increase-value/decrease-value setting device 14 sets, for travel control device 100, speed decrease value −va and speed increase value +vb of vehicle 1 during automatic travel. These values, “V′,” “−va,” and “+vb” are parameters used for the automatic travel of vehicle 1.

Target-vehicle-speed setting device 13 and increase-value/decrease-value setting device 14 include an information input interface, such as a display having a touch panel and being disposed, for example, on a dashboard (not illustrated) of a driver's seat, and target-vehicle-speed setting device 13 and increase-value/decrease-value setting device 14 receive setting of the aforementioned parameters input by a driver. Target vehicle speed V′, speed decrease value −va, and speed increase value +vb may appropriately be referred to as “setting information.”

Navigation device 20 outputs, to travel control device 100, road information including information on a road on which vehicle 1 is traveling and the current position of vehicle 1. Navigation device 20 also outputs device state information on the device state of navigation device 20 to travel control device 100.

Note that, the road information includes road grade information indicating road grades at places of the road for generation of the below-mentioned travel schedule. The road grade information is data in which horizontal positions (latitude and longitude information or the like) of the places of the road are associated with altitudes (road altitudes) at the corresponding positions, for example. Road information also includes information on a road type of the road on which vehicle 1 is traveling. For example, the road information includes road information indicating whether vehicle 1 is traveling on a local road or on an expressway.

Vehicle-information obtaining device 30 obtains vehicle information indicating driver operation information and/or the state of vehicle 1, and outputs the vehicle information to travel control device 100. For example, vehicle-information obtaining device 30 includes accelerator sensor 31 that detects the depressed amount of an accelerator pedal, brake switch 32 that detects whether or not a brake pedal is stepped on, shift lever 33, turn signal switch 34, and vehicle-speed sensor 35 that detects vehicle speed V of vehicle 1.

Travel control device 100 generates a travel schedule including the driven travel and coasting travel based on the aforementioned setting information, road information, and vehicle information. Then, travel control device 100 controls each part of vehicle 1 so that vehicle 1 travels in accordance with the generated travel schedule. However, travel control device 100 prohibits the coasting travel based on the device state information output from navigation device 20 as describe below.

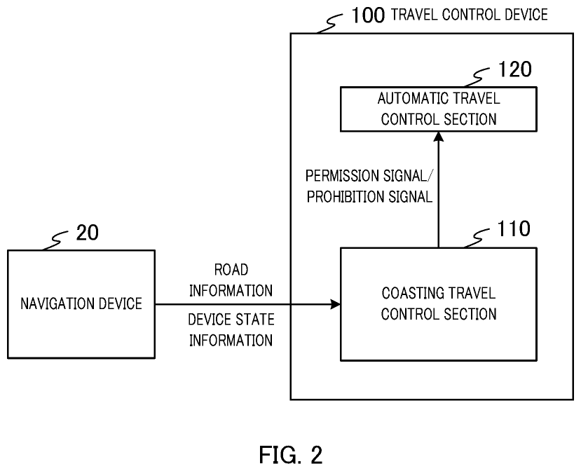

FIG. 2 illustrates an example of functional blocks of travel control device 100. FIG. 2 also illustrates navigation device 20 illustrated in FIG. 1 in addition to travel control device 100. As illustrated in FIG. 2, travel control device 100 includes coasting travel control section 110 and automatic travel control section 120.

Navigation device 20 outputs the road information and device state information as described above. The road information and device state information output from navigation device 20 are input to coasting travel control section 110 of travel control device 100.

Based on the road information output from navigation device 20, coasting travel control section 110 outputs, to automatic travel control section 120, a permission signal for permitting the coasting travel or a prohibition signal for prohibiting the coasting travel.

For example, coasting travel control section 110 outputs the prohibition signal to automatic travel control section 120 when coasting travel control section 110 receives from navigation device 20 the road information indicating that there is a curve ahead of traveling vehicle 1 (e.g., within 500 m ahead from the current position). That is, when there is a curve ahead of traveling vehicle 1, vehicle 1 will be prohibited from performing the coasting travel even during the coasting travel.

Coasting travel control section 110 outputs the prohibition signal in the cases of the following road information, for example, besides the case where there is a curve ahead of the traveling vehicle as described above.

The road on which vehicle 1 is traveling is a local road (a road other than an expressway).
The road on which vehicle 1 is traveling is a ramp of an expressway.
The road on which vehicle 1 is traveling is a frontage road of an expressway.
The road on which vehicle 1 is traveling is an interchange.
The road on which vehicle 1 is traveling is an intersection.
No link is set ahead of traveling vehicle 1.

That is, coasting travel control section 110 outputs the prohibition signal when the road information indicating that the coasting travel would run vehicle 1 into a danger is output from navigation device 20.

Coasting travel control section 110 outputs the prohibition signal to automatic travel control section 120 when coasting travel control section 110 receives, from navigation device 20, at least one of the items of road information indicated above as examples. On the other hand, coasting travel control section 110 outputs the permission signal to automatic travel control section 120 when coasting travel control section 110 does not receive, from navigation device 20, any of the items of road information indicated above as examples.

Based also on the device state information output from navigation device 20, coasting travel control section 110 outputs, to automatic travel control section 120, the permission signal for permitting the coasting travel or the prohibition signal for prohibiting the coasting travel.

For example, navigation device 20 outputs the prohibition signal to automatic travel control section 120 when the device state information indicating that vehicle 1 does not match a road on a map (i.e., vehicle 1 is off the road on the map) is output from navigation device 20.

Specifically, when a GPS signal received from a position measurement system includes noise, vehicle 1 may be off the road on the map of navigation device 20. When vehicle 1 is off the road on the map, navigation device 20 outputs the device state information indicating that vehicle 1 does not match the road on the map. In this case, coasting travel control section 110 outputs the prohibition signal to automatic travel control section 120.

Coasting travel control section 110 outputs the prohibition signal in the cases of the following device state information, for example, besides the case where vehicle 1 does not match the road as described above.

Malfunctions of navigation device 20.
GPS signals cannot be received.
A link cannot be specified.

That is, coasting travel control section 110 outputs the prohibition signal when coasting travel control section 110 receives, from navigation device 20 the device state information indicating that navigation device 20 has not been successful in outputting appropriate navigation information. In other words, coasting travel control section 110 prohibits the coasting travel when the reliability (accuracy) of the current position of vehicle 1 output from navigation device 20 is low.

Coasting travel control section 110 outputs the prohibition signal to automatic travel control section 120 when coasting travel control section 110 receives, from navigation device 20, at least one of the items of device state information indicated above as examples. On the other hand, coasting travel control section 110 outputs the permission signal to automatic travel control section 12 when coasting travel control section 110 does not receive, from navigation device 20, any of the items of device state information indicated above as examples.

Automatic travel control section 120 generates the travel schedule including the driven travel and coasting travel, and causes vehicle 1 to travel in accordance with the generated travel schedule based on the current position of vehicle 1.

For example, automatic travel control section 120 achieves travel at a speed in accordance with the travel schedule by controlling the fuel injection quantity of engine 3 and/or the like via power transmission ECU 11 during the driven travel. In addition, automatic travel control section 120 disconnects clutch 4 via power transmission ECU 11 during the coasting travel. Moreover, automatic travel control section 120 controls each part of braking device 40 appropriately to stop vehicle 1.

Here, a description will be given of an example of the travel schedule. Automatic travel control section 120 generates, sequentially at a constant interval, a travel schedule for a predetermined travel distance from the current position of vehicle 1 or a travel schedule for a predetermined time period from the current time. These travel schedules are generated to satisfy travel conditions that an average moving vehicle speed is target vehicle speed V′, the maximum vehicle speed during the coasting travel is equal to or less than “Vₘₐₓ′=V′+vb,” and the minimum vehicle speed during the coasting travel is equal to or greater than “Vₘᵢₙ′=V′−va,” for example

For example, automatic travel control section 120 generates the travel schedule for preferentially performing the coasting travel on a downhill road based on the road information. Further, automatic travel control section 120 generates the travel schedule including switching from the driven travel to the coasting travel in front of a crest on condition that the vehicle speed will be equal to or greater than acceptable minimum vehicle speed Vₘᵢₙ′ at the crest where the road changes from an upslope to a downslope.

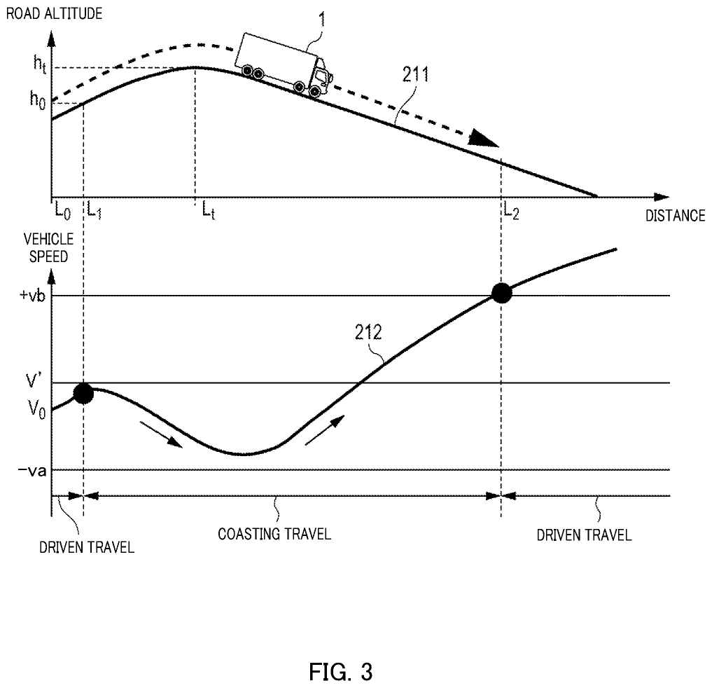

FIG. 3 illustrates an example of road grade information and a travel schedule. For example, the road grade information includes information indicating a road altitude per horizontal distance (road distance) from current position L₀ of vehicle 1 as illustrated by upper solid line 211 in FIG. 3. Note that the horizontal distance from current position L₀ of vehicle 1 may be replaced by the elapsed time from the current time. In addition, the road altitude may be replaced by the road grade based on the relationship with road altitudes in the front and in the rear. The road grade information of solid line 211 indicates that current position L₀ of vehicle 1 is in the middle of an upslope and that there is a downslope immediately after the upslope.

For example, automatic travel control section 120 successively determines whether or not a part (hill crest) where the road changes from an upslope to a downslope is present within a predetermined distance range of the road ahead on the basis of the road grade information.

Then, when there is a hill crest, automatic travel control section 120 determines whether the vehicle can travel through the hill crest by the coasting travel in the case where switching to the coasting travel is performed at position L₁ immediately after current position L₀. That is, automatic travel control section 120 calculates whether or not the vehicle speed at the hill crest will be equal to or greater than acceptable minimum vehicle speed Vₘᵢₙ′. Automatic travel control section 120 performs the above-mentioned calculation based on current vehicle speed v₀, the travel resistance coefficient of vehicle 1 determined in advance by experiments and the like, and the road grade information.

When switching to the coasting travel is performed at the upslope, the vehicle speed is gradually reduced. However, in the case where the speed is high or the distance to the crest is short enough to maintain the vehicle speed at acceptable minimum vehicle speed Vₘᵢₙ′ (V′−va) or greater at a position near the downslope, the above-mentioned travel condition that the minimum vehicle speed of the coasting travel is equal to or greater than acceptable minimum vehicle speed Vₘᵢₙ′ can be satisfied even when switching to the coasting travel is performed at the upslope.

When automatic travel control section 120 determines that the vehicle can pass through the hill crest by the coasting travel, automatic travel control section 120 determines that switching to the coasting travel is performed at position L₁ immediately after position L₀, and that the coasting travel is maintained until the vehicle reaches position L₂ where the vehicle speed falls outside the range of Vₘᵢₙ′ to Vₘₐₓ′ (V′−va to V′+vb), for example. Then, automatic travel control section 120 generates the travel schedule in which switching to the coasting travel is performed at point L₁ and the coasting travel is maintained until the vehicle reaches point L₂ as indicated by lower solid line 212 in FIG. 3.

Specifically, automatic travel control section 120 calculates estimation value vₜ of the vehicle speed at crest position Lₜ in the case where vehicle 1 performs the coasting travel to crest position Lₜ (such an estimation value is hereinafter referred to as “estimation crest vehicle speed”), for example, using following Equation (1).

$${v}_{t} = \sqrt{\begin{matrix}\frac{2}{M} \{ \frac{1}{2} {Mv}_{0}^{2} + {Mgh}_{0} - \\ ( {Mgh}_{t} + λ \cdot {v}_{0}^{2} \cdot g \cdot \frac{Δ x}{cos {θ}_{0}} + μ \cdot Mg \cdot Δ x ) \}\end{matrix}} \qquad ( Equation 1 )$$

Here, M represents the current vehicle weight of vehicle 1, g the gravitational acceleration, h₀ the altitude at current position L₀ of vehicle 1, hₜ the altitude at crest position Lₜ, μ the roll resistance coefficient of vehicle 1, and Δx the distance (road distance) in the horizontal direction from current position L₀ to crest position Lₜ.

Then, when the calculated estimation crest vehicle speed vₜ is equal to or greater than the set acceptable minimum vehicle speed Vₘᵢₙ′, automatic travel control section 120 determines that, when the coasting travel is being performed, the coasting travel is maintained, whereas, when the driven travel is being performed, the driven travel is switched to the coasting travel. That is, automatic travel control section 120 generates the travel schedule indicated by solid line 212 in FIG. 3, for example, and controls vehicle 1 in accordance with the schedule.

Such a travel schedule including a coasting travel section determined based on the road grade information effectively improves the fuel economy of vehicle 1. In addition, with the control of vehicle 1 to travel in accordance with the travel schedule, driver's successive accelerator operation is unnecessary. In the following description, the automatic travel in accordance with the travel schedule including the driven travel and the coasting travel which is generated based on the road grade information is referred to as “eco-map cruise travel.”

Even when automatic travel control section 120 causes vehicle 1 to perform the coasting travel in accordance with the generated travel schedule, automatic travel control section 120 prohibits the coasting travel of vehicle 1 when the prohibition signal is output from coasting travel control section 110. In other words, automatic travel control section 120 causes the vehicle 1 to perform the coasting travel when the generated travel schedule indicates the coasting travel and the permission signal is output from coasting travel control section 110.

A description will be given of an example of operation of travel control device 100.

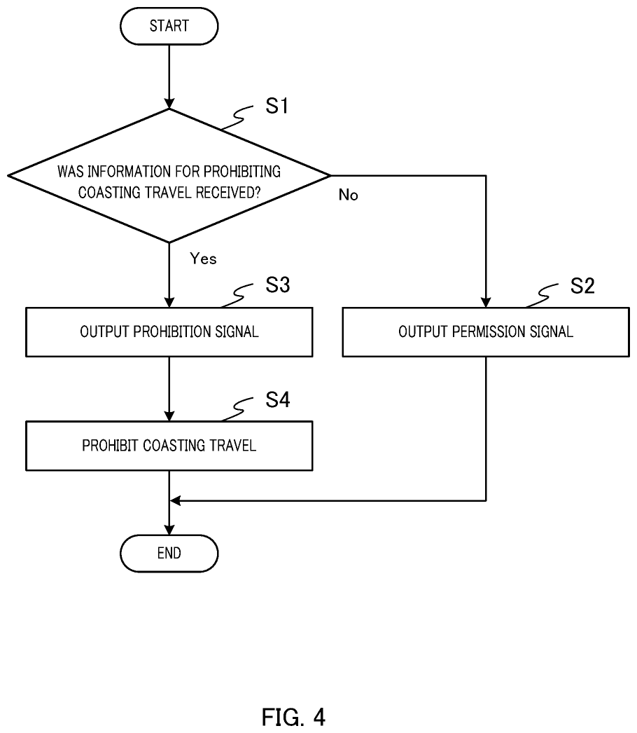

FIG. 4 is a flowchart illustrating an example of operation of travel control device 100. Travel control device 100 carries out processing in the flowchart illustrated in FIG. 4 on a predetermined cycle, for example, when travel control device 100 receives the operation of the eco-map cruise travel from the driver. Note that, it is supposed that automatic travel control section 120 are causing vehicle 1 to perform the coasting travel according to the eco-map cruise travel.

To begin with, coasting travel control section 110 determines whether or not coasting travel control section 110 has received, from navigation device 20, the road information or device state information for prohibiting the coasting travel (step S1). When coasting travel control section 110 determines that coasting travel control section 110 has not received, from navigation device 20, any road information or any device state information for prohibiting the coasting travel (“No” at S1), coasting travel control section 110 outputs the permission signal to automatic travel control section 120 (step S2). Automatic travel control section 120 thus causes vehicle 1 to perform the coasting travel.

On the other hand, when coasting travel control section 110 determines that coasting travel control section 110 has received, from navigation device 20, the road information or the device state information for prohibiting the coasting travel (“Yes” at S1), coasting travel control section 110 outputs the prohibition signal to automatic travel control section 120 (step S3).

When the prohibition signal is output at step S3, automatic travel control section 120 prohibits the coasting travel of vehicle 1 (step S4). Vehicle 1 thus performs the driven travel.

As described above, travel control device 100 includes: automatic travel control section 120 that causes vehicle 1 to travel in accordance with the travel schedule including the driven travel and the coasting travel; and coasting travel control section 110 that prohibits the coasting travel with respect to automatic travel control section 120 based on the device state information indicating the device state of navigation device 20 to be output from navigation device 20. Travel control device 100 can thus prohibit the coasting travel of vehicle 1 depending on the device state of navigation device 20, so as to cause vehicle to perform the coasting travel appropriately.

Note that, although the above descriptions have been given in relation to a case where automatic travel control section 120 prohibits the coasting travel of vehicle 1 and causes vehicle 1 to perform the driven travel when the prohibition signal is output, automatic travel control section 120 may also end the eco-map cruise travel.

This application is based on Japanese Patent Application No. 2017-018712 filed on Feb. 3, 2017, the disclosure of which is incorporated herein by reference in its entirety.

### INDUSTRIAL APPLICABILITY

The travel control device according to the present disclosure is suitable for use in a vehicle that travels in accordance with a travel schedule including driven travel and coasting travel.

### REFERENCE SIGNS LIST

20 Navigation device
100 Travel control device
110 Coasting travel control section
120 Automatic travel control section

What is claimed is:

1. A travel control device, comprising:
an automatic travel control section that causes a vehicle to travel in accordance with a travel schedule including driven travel and coasting travel; and
a coasting travel control section that prohibits the coasting travel with respect to the automatic travel control section when the coasting travel control section receives, from a navigation device, information indicating that the navigation device is not successful in outputting appropriate navigation information.

2. The travel control device according to claim 1, wherein
the coasting travel control section prohibits the coasting travel when information indicating that the vehicle is off a road on a map is output from the navigation device.

3. The travel control device according to claim 1, wherein
the coasting travel control section prohibits the coasting travel when road information indicating that a type of a road on which the vehicle travels is not an expressway is output from the navigation device.

4. The travel control device according to claim 1, wherein
the coasting travel control section prohibits the coasting travel when road information indicating that a type of a road on which the vehicle travels is an interchange is output from the navigation device.

5. The travel control device according to claim 1, wherein
the coasting travel control section prohibits the coasting travel when road information indicating that a road on which the vehicle travels curves is output from the navigation device.

6. The travel control device according to claim 1, wherein
the coasting travel control section prohibits the coasting travel when road information indicating that a road on which the vehicle travels is an intersection is output from the navigation device.

7. A travel control method, comprising:
causing a vehicle to travel in accordance with a travel schedule including driven travel and coasting travel; and
prohibiting the coasting travel with respect to an automatic travel control section when information indicating that a navigation device is not successful in outputting appropriate navigation information is received from the navigation device.
